(19) United States
(12) Patent Application Publication
(10) Pub. No.: US 2002/0032054 A1
(43) Pub. Date: Mar. 14, 2002

(54) Input device for game

(75) Inventor: Hayato Hosoya, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 09/949,065

(22) Filed: Sep. 7, 2001

(30) Foreign Application Priority Data
Sep. 8, 2000 (JP) 2000-272896

(51) Int. Cl. A63F 13/00

(52) U.S. Cl. 463/35

(57) ABSTRACT

A maximum value of the magnitude of sound detected by a microphone is detected by a peak hold circuit and is sent to a CPU. A discriminating unit is provided in the CPU. In the discriminating unit, plural thresholds are set and it is discriminated which threshold the maximum value exceeds. Any of switching means H, M and L is switched according to the discrimination and a switching signal is generated. According to a type of the switching signal, proceedings of a game program vary.

### BACKGROUND OF THE INVENTION

1. Field of the Invention

The present invention relates to an input device for a game that enables proceedings of a game by recognition of sound for example.

2. Description of the Related Art

For an input device for a game, a controller such as a pad type has been generally used. This type of controller enables proceedings of a game program by operating a pushbutton or a lever provided to the controller or by combinational operation of plural buttons.

For a method of operating the input device for a game, there is a method based upon a voice. For example, in a combative action game, an aural signal is converted to a signal for operation when an operator makes a voice to instruct operation of a character, and operation according to the instruction is given to the character.

However, the abovementioned conventional type input device for a game has a problem that it cannot be manufactured at a low cost because, for a circuit for recognizing a voice, an IC which is high-priced though capable of complex processing is required and a circuit is complex. Also, only a person who can speak language at an extent recognizable as a voice can operate the input device and operation is difficult for an infant who can speak very limited language.

### SUMMARY OF THE INVENTION

The invention is made to solve the abovementioned problems and has an object of providing an input device for a game which can be manufactured at a low cost and can be also operated by an infant immature in language ability.

The input device for a game according to the invention is provided with sound detecting means that detects external sound and a discriminating unit that discriminates the magnitude of sound detected by the sound detecting means and is characterized in that when the magnitude detected by the discriminating unit of sound is equal to/larger than a predetermined value, a switching signal is sent to a game machine storing a game program.

For example, a controller that sends a signal to the game machine by wire or radio is provided in a position apart from the game machine, and the sound detecting means, the discriminating unit and a control unit that sends the switching signal to the game machine are provided to the controller.

In the discriminating unit, plural thresholds are set, the discriminating unit discriminates which threshold the magnitude detected by the discriminating unit of sound exceeds, a different switching signal is sent to a game machine depending upon the exceeded threshold, and the game machine changes the proceedings of a game program according to a type of the switching signal.

According to the invention, since only the magnitude of sound has only to be recognized and an IC that enables complex processing and has high performance is not required to be provided, a high-cost IC is not required to be mounted and the input device for a game according to the invention can be manufactured at a low cost. As different switching signals are output depending upon the magnitude of a voice, even a small child immature in language ability can operate it.

Display means or sounding means for giving guidance for operation related to game contents according to a game program is provided and the game machine may be operated so that when guidance for operation is given from the display means or the sounding means, the game program is turned to a standby mode for receiving the switching signal and the game program proceeds when the switching signal is received in the standby mode or after predetermined time elapses without receiving the switching signal.

### BRIEF DESCRIPTION OF THE DRAWINGS

FIG. 1 is a circuit diagram showing the inside of an input device for a game according to the present invention;

FIG. 2 is a circuit diagram showing a control unit; and

FIG. 3 is a flowchart.

### DETAILED DESCRIPTION OF THE PREFERRED EMBODIMENT

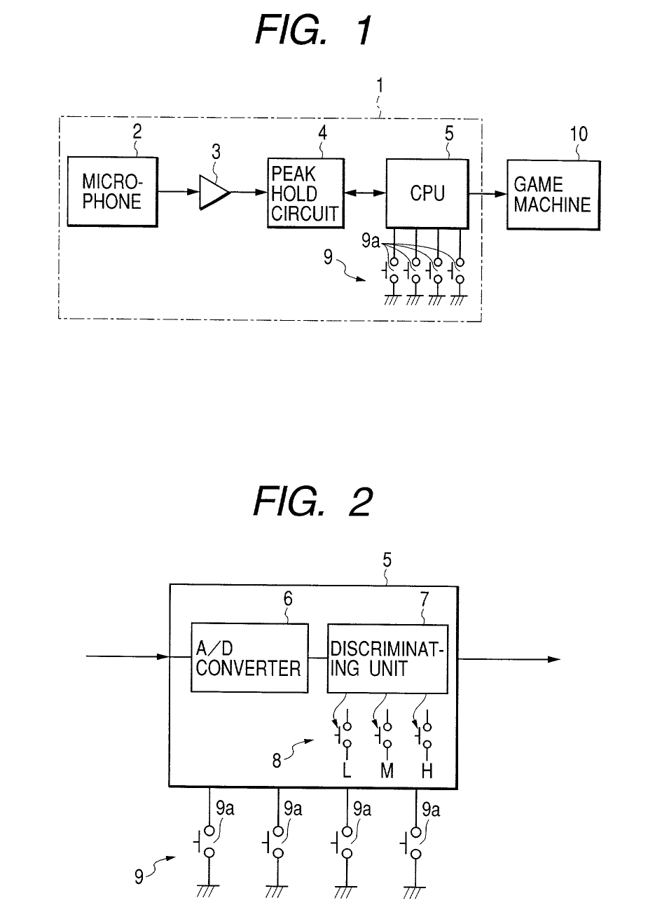

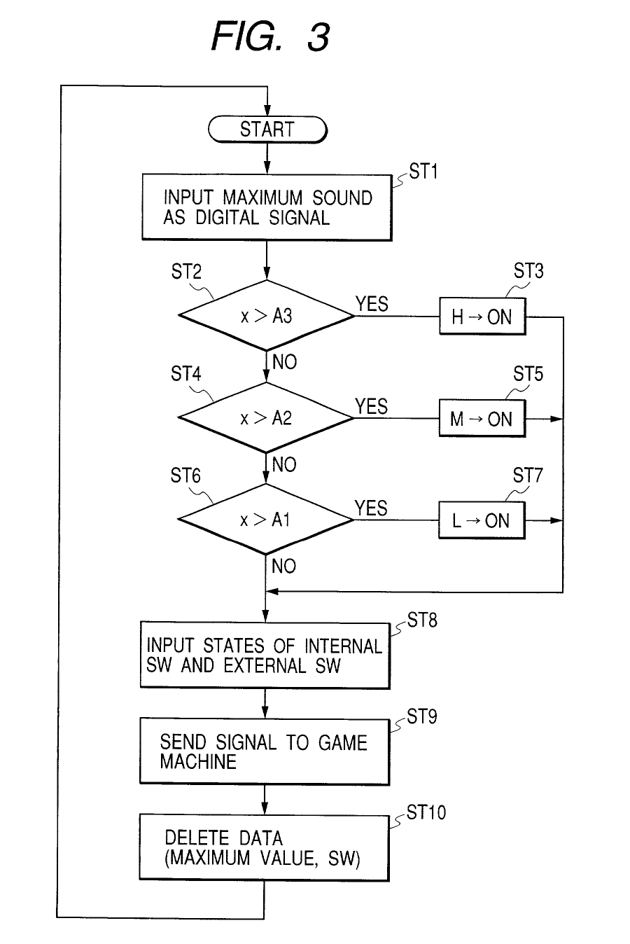

FIG. 1 is a circuit diagram showing an example of an input device for a game according to the present invention, FIG. 2 is a circuit diagram showing a control unit and FIG. 3 is a flowchart.

For the input device for a game shown in FIG. 1, a controller 1 is provided in a position apart from a game machine 10 in which a game program is stored. The controller 1 is connected to the game machine 10 via a predetermined cable by wire or by radio using an electric wave and infrared rays as a communication medium. Further, the game machine 10 is connected to a television (TV) set not shown and the controller 1 is operated based upon an image displayed on a screen and sound produced from a speaker provided in the TV set.

A microphone 2 which is sound detecting means for detecting external sound, an amplifier 3, a peak hold circuit 4 and a CPU 5 are provided in the controller 1. The microphone 2 is connected to the amplifier 3, the amplifier 3 is connected to the peak hold circuit 4 and the peak hold circuit 4 is connected to the CPU 5.

The microphone 2 receives sound (voice) made by an operator who operates the controller 1 and generates an analog signal based upon this voice. When a loud voice is made, the amplitude of an analog signal is large and when a small voice is made, the amplitude is small. When no voice is detected, no waveform is acquired.

The analog signal is sent to the amplifier 3. The amplifier 3 shapes the analog signal in the form of amplification and the like and sends it to the peak hold circuit 4. The peak hold circuit 4 detects the maximum value of the amplitude of an output level based upon the waveform of the analog signal and stores the maximum value at that time. A signal showing the maximum value of the amplitude is sent to the CPU 5 as a control unit.

As shown in FIG. 2, an A/D converter 6, a discriminating unit 7 and an internal switch 8 composed of plural switching means H, M and L are provided to CPU 5. The maximum value sent to the CPU 5 is sent to the A/D converter 6 and the analog signal is converted to a digital signal.

The digital signal is sent to the discriminating unit 7. In the discriminating unit 7, plural thresholds are set, it is discriminated which threshold the digital signal showing the maximum value in the magnitude of the detected sound exceeds and any of the switching means H, M and L is turned on based upon the discrimination. A switching signal is sent from any of the switching means H, M and L to the game machine 10, has an effect on the contents of a game and subsequent processing is continued.

Three thresholds are set in the discriminating unit 7. Hereby, when a loud voice is detected, the switching means H is turned on and when a small voice is detected, the switching means L is turned on. When a voice between a loud voice and a small voice is detected, the switching means M is turned on. However, the number of set thresholds is not limited to three and one, two, four or more thresholds may also be set according to the contents of a game program.

An external switch 9 is provided to the controller 1. The external switch 9 enables input from outside the controller 1 and the corresponding one of switching elements 9a provided inside the controller 1 is switched by pressing the external switch 9.

The external switch 9 is connected to the CPU 5 and a signal generated by operation of the external switch 9 is sent to the game machine 10 and has an effect on the contents of a game.

Next, referring to FIG. 3, a method of switching a signal in the controller 1 will be described. In an example shown in FIG. 3, three thresholds (A1, A2, A3) different in an output level of the magnitude of sound are set. However, the relation among the thresholds A1, A2 and A3 is A3>A2>A1.

In a step 1 (ST1), the maximum value in magnitude of a voice (an analog signal) is converted to a digital signal in the A/D converter 6 of CPU 5. Suppose that the maximum value at this time is x.

In ST2, it is discriminated whether x is larger than the threshold A3 or not. When it is judged that x is larger than the threshold A3 (Yes), processing proceeds to ST3 and the switching means H is turned on. When it is judged in ST2 that x is equal to or smaller than the threshold A3 (No), processing proceeds to ST4.

In ST4, it is discriminated whether x is larger than the threshold A2 or not. When x is larger than the threshold A2 (Yes), processing proceeds to ST5 and the switching means M is turned on. In case x is equal to or smaller than the threshold A2 (No), processing proceeds to ST6.

In STG, it is discriminated whether x is larger than the threshold A1 or not. When x is larger than the threshold A1 (Yes), processing proceeds to ST7 and the switching means L is turned on. When x is equal to or smaller than the threshold A1 (No), processing proceeds to ST8. At this time, when x is smaller than the threshold A1, it is judged that no switching means H, M L is turned on.

In ST8, a state of the internal switch 8 composed of the switching means H, M and L is fetched and a switching signal is generated by any of the switching means H, M and L. When the external switch 9 is operated, a state of the switching element 9a of the external switch 9 is fetched and a predetermined signal is generated.

Processing proceeds to ST9, and CPU 5 sends a switching signal generated by the internal switch 8 and a signal generated by the external switch 9 to the game machine 10. In the game machine 10, the proceedings of a game program are varied according to a type of the switching signal.

When the transmission of the switching signal is finished, processing proceeds to ST10 and the turned on internal switch 8 is turned off. The CPU 5 sends a clear signal to the peak hold circuit 4 to delete data showing the maximum value held in the peak hold circuit 4.

As described above, in the input device for a game according to the invention, the abovementioned processing from ST1 to ST10 is repeated when an operator makes a voice toward the microphone 2 and operates the external switch 9 if necessary according to guidance by display on the TV screen and guidance by sound produced from a speaker together with display on the TV screen.

If the switching of the switching means M does not function enough, a range between the threshold Al and the threshold A2 may be also set to a little larger value. That is, only if a rather loud voice is detected, a switching signal by the switching means H is generated and only if a rather small voice is detected, a switching signal by the switching means L is generated.

The abovementioned controller 1 can be used for a game machine for an infant. For example, two thresholds are set and when the upper threshold is exceeded, a switching signal meaning “yes” may also be generated and if the lower threshold is exceeded, a switching signal meaning “no” may also be generated.

The input device for a game according to the present invention is not limited to the abovementioned embodiment, for example, the game machine may also operate so that when guidance for operation is given from a TV set (display means) or a speaker (sounding means), a standby mode in which a game program receives a switching signal is turned on, and the game program proceeds when the switching signal is received in the standby mode or after predetermined time elapses without receiving a switching signal.

In the abovementioned invention, as processing is performed based upon the magnitude of sound, a high-cost circuit having high performance is not required to be provided and as a circuit is not complex, the input device for a game can be manufactured at a low cost. In addition, even an infant who does not have enough ability of conversation can enjoy a game.

What is claimed is:

1. An input device for a game, comprising sound detecting means that detects external sound; and a discriminating unit that discriminates the magnitude of sound detected by the sound detecting means, wherein when the magnitude detected by the discriminating unit of sound is equal to/larger than a predetermined value, a switching signal is sent to a game machine storing a game program.

2. An input device for a game according to claim 1, wherein a controller that sends a signal to the game machine by wire or radio is provided in a position apart from the game machine, and wherein the sound detecting means, the discriminating unit and a control unit that sends the switching signal to the game machine are provided to the controller.

3. An input device according to claim 1, wherein, in the discriminating unit, plural thresholds are set, wherein the discriminating unit discriminates which threshold the magnitude detected by the discriminating unit of sound exceeds, wherein a different switching signal is sent to a game machine depending upon the exceeded threshold, and wherein the game machine changes the proceedings of a game program according to a type of the switching signal.

4. An input device for a game according to claim 1, wherein display means or sounding means for giving guidance for operation related to game contents according to a game program is provided, and wherein the game machine is operated so that when guidance for operation is given from the display means or the sounding means, the game program is turned to a standby mode for receiving the switching signal and the game program proceeds when the switching signal is received in the standby mode or after predetermined time elapses without receiving the switching signal.
